(19) United States
(12) Patent Application Publication
(10) Pub. No.: US 2005/0282681 A1
(43) Pub. Date: Dec. 22, 2005

(54) Washing machine gearbox conical structure

(76) Inventors: René Bourquim, (US); René Bourquim Galves, Mairinque (BR)

Correspondence Address: SHERIDAN ROSS PC, 1560 BROADWAY, SUITE 1200, DENVER, CO, 80202, US

(21) Appl. No.: 11/118,105

(22) Filed: Apr. 28, 2005

(30) Foreign Application Priority Data
Apr. 29, 2004 (BR) MU8400819

(51) Int. Cl. F16D 11/00

(52) U.S. Cl. 475/331

(57) ABSTRACT

An improved washing machine gearbox is provided that possesses improved performance and durability with respect to mechanical vibration and corrosion in relation to other models usually found in the market. One embodiment of the present invention employs a gearbox with a conical upper portion that is constructed of a high-resistance polymer that also supplies a location for the support of an inner shaft that is ultimately interconnected to an agitator of the washing machine.

This application claims the benefit of Brazilian Utility Model Application Serial No. MU8400819, filed Apr. 29, 2004, which is incorporated by reference in its entirety herein. This application is also related to Brazilian Utility Model Application Serial Nos. MU8400820 and MU8401086, filed Apr. 29, 2004 and May 24, 2004, respectively, which are both incorporated by reference in their entirety herein.

### FIELD OF THE INVENTION

The present invention relates to an improvement of a structural component that comprises an upper part of a washing machine gearbox.

### BACKGROUND OF THE INVENTION

Household appliances are definitely great helpers in the performance of domestic chores. Regarding the washing of clothes, vertical and horizontal washing machines have been developed, that have tubs equipped with motor-driven shafts that perform balancing or rotational agitating motions during washing for complete suction of water from the clothes.

The motor driven shafts are rotatably interconnected to a cylindrical gearbox that is closed at the top by metallic, conical structure through which a primary shaft is projected whose outer perimeter is coupled to a centrifuging mechanism and to a tub. In addition, a secondary inner shaft is rotatably interfaced to an inner perimeter of the conical structure that is coupled at the bottom to an oscillatory motion mechanism that transmits power to a step down gear assembly. The gear assembly is comprised of a support that is equipped radially and perpendicularly with shafts coupled to cylindrical gearings whose tangencies mesh with a common central gear. The support is also interconnected to the secondary inner shaft that passes through the primary shaft that interconnects to a central washing propeller.

In its ordinary form, the above device works and meets minimum mechanical performance required, however, because clothes washing requires the use of water and alkaline products, components of the washing machine corrosionally degrade with time. Thus, the exteriors of gearboxes traditionally used become worn, sometimes reducing the life span of the product.

Thus, it is a long felt need in the field of washing machine manufacturing to provide a product that has an increased life span. The following disclosure describes a washing machine that employs a new and improved gearbox that is partially comprised of a high-resistance polymer that resists the effects of corrosion.

### SUMMARY OF THE INVENTION

It is one aspect of the present invention to provide a washing machine that possesses increased performance and durability, especially in the gearboxes employed therein, and that reduce mechanical vibrations and the possibility of corrosion.

More precisely, one embodiment of the present invention is made up of a cylindrical gearbox, equipped in its inner perimeter with epicycloidal step down gears, formed in a planetary assembly, whose tractional resultant is transmitted by an inner shaft that passes through a structural conical component made of high-resistance polymer that seals the top of the cylindrical gearbox and accommodates the secondary inner shaft that is connected to a washing machine agitator.

It is also an aspect of the invention to provide a new upper component for the gearbox that is of low cost, yet robust, safe and practical.

It was based on the above described drawbacks that, after countless research and studies, the inventors, created and developed the present invention, conceiving an improvement in the closing structure of the cylindrical gearbox preferably designed of a high-resistance polymer, so as to provide greater resistance to alkaline agents that inevitably contact the cylindrical gearbox. Not only the mechanical and functional qualities are considered in this manufacturing design, but also the shape, arrangement and location of this component that increase efficiency without any burden whatsoever.

Therefore, the present invention is designed with the intention of obtaining a device that is more efficient, longer lasting, light and less expensive than machines in the art, and that avoids the above-mentioned drawbacks. Further, one skilled in the art will appreciate that the device in question is extremely simple in construction and is quite feasible, but nevertheless possesses excellent practical and functional aspects.

Thus, it is one aspect of the present invention to provide a washing machine gearbox that comprises:

a conical top section, said conical top section being fashioned substantially of high resistance polymer and having a cylindrical flange positioned thereon;

a housing interconnected, adjacent to a top edge thereof, to said conical top section, said housing rotatably securing a plurality of epicycloidal gears that are interconnected to a centralized sun gear;

a generally hollow outer primary shaft interconnected to an inner surface of said cylindrical flange; and

a secondary inner shaft positioned in said outer primary shaft and to a support rotatably interconnected to said epicycloidal gears.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a top perspective view of a gearbox interconnected to an outer primary shaft and rotatably interconnected to an inner secondary shaft of one embodiment of the present invention;

FIG. 2 is a bottom perspective view of the embodiment shown in FIG. 1;

FIG. 3 is an exploded perspective view of the embodiment shown in FIG. 1;

FIG. 4 is a front elevation view of the embodiment of the present invention shown in FIG. 1;

FIG. 5 is a top plan view of the embodiment of the present invention shown in FIG. 1;

FIG. 6 is a front cross-sectional view of the embodiment of the present invention shown in FIG. 1; and

FIG. 7 is a cross-sectional view of a generic washing machine that employs one embodiment of the present invention.

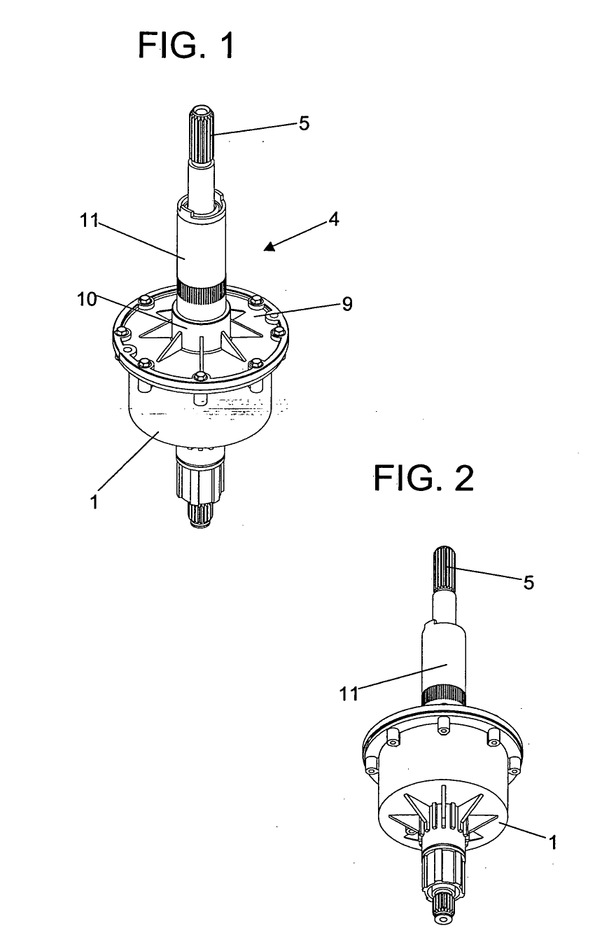

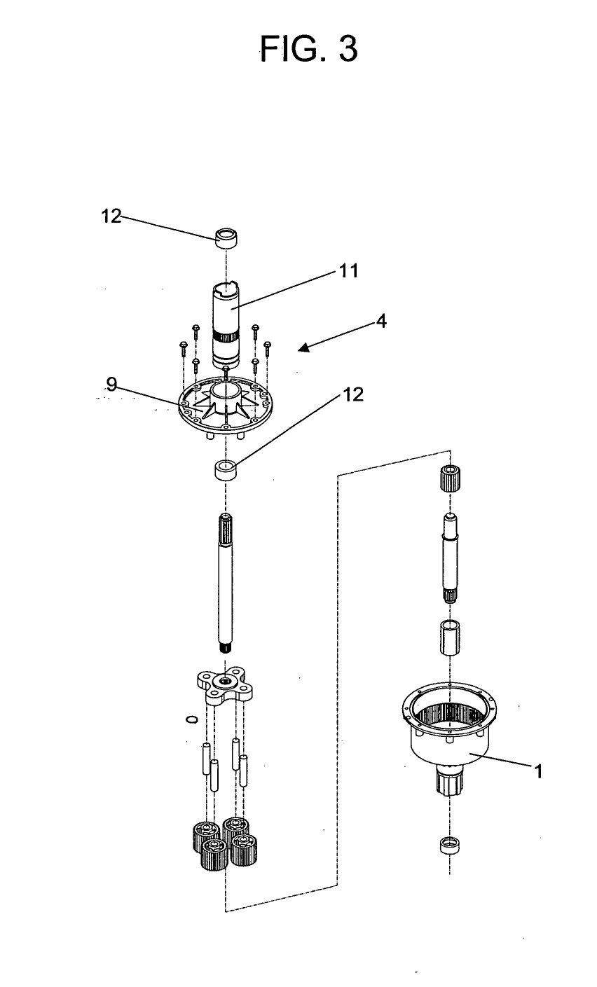

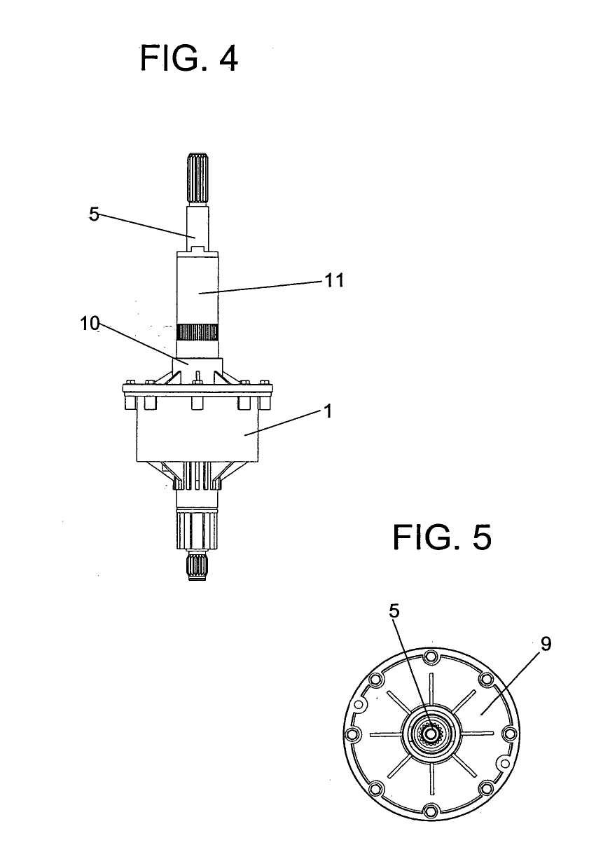

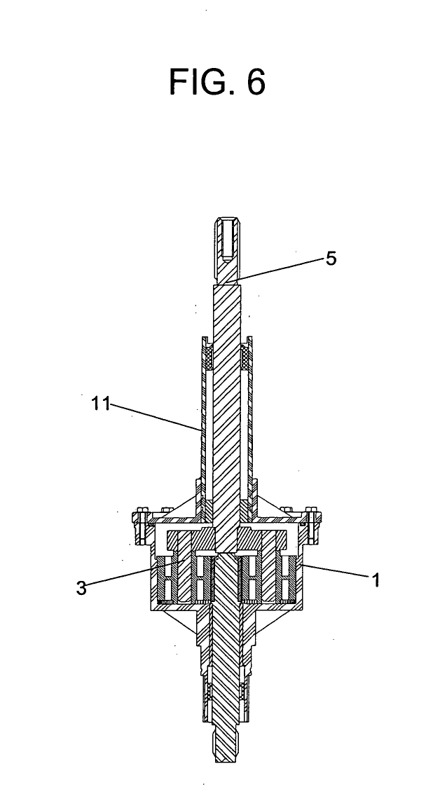

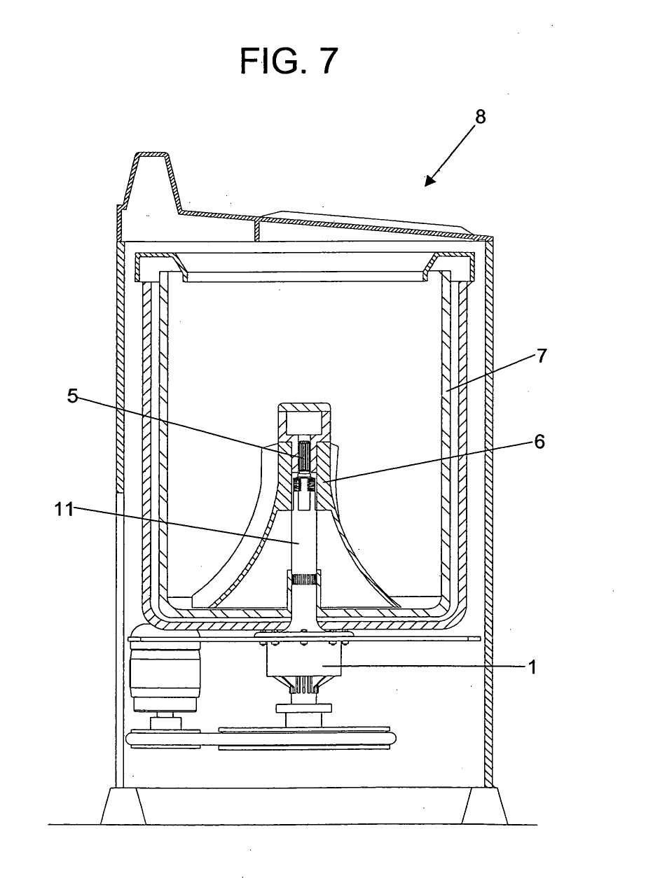

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

One embodiment of the present invention is a washing machine gearbox 1 is equipped in its inner perimeter with epicycloidal gears 3 formed in a planetary assembly. The gearbox 1 also includes a conical structure 4 that accommodates and bears a secondary inner shaft 5 that is coupled to the epicycloidal gears 3 and a central washing agitator 6. An outer primary shaft 11 of the central gearbox 1 is coupled to a centrifugal mechanism and to a tub 7 of the washing machine 8.

The conical structure 4 is preferably made of a high-resistance polymer and comprises a cylindrical base 9 interconnected to a reinforced cylindrical flange 10, inside of which the outer primary shaft 11 is coupled. The outer primary shaft 11 has a narrow external surface and internally secures two bushings 12 that guide the rotation of the secondary inner shaft 5. Thus, the gearbox 1 will have greater durability, in addition to allowing easier maintenance of its internal components.

One skilled in the art will appreciate that the improved gearbox 1 of the present invention is characterized as a mechanical component of great utility innovation having, countless differences in relation to conventional models in a consumer market, including constructive and functional technical features completely different from those belonging to the prior art.

While various embodiment of the present invention have been described in detail, it is apparent that modifications and alterations of those embodiments will occur to those skilled in the art. However, it is to be expressly understood that such modifications and alterations are within the scope and spirit of the present invention, as set forth in the following claims.

1. A washing machine gearbox comprising:
a conical top section, said conical top section being fashioned substantially of high resistance polymer and having a cylindrical flange positioned thereon;
a housing interconnected, adjacent to a top edge thereof, to said conical top section, said housing rotatably securing a plurality of epicycloidal gears that are interconnected to a centralized sun gear;
a generally hollow outer primary shaft interconnected to an inner surface of said cylindrical flange; and
a secondary inner shaft positioned in said outer primary shaft and to a support rotatably interconnected to said epicycloidal gears.
